(19) United States
(12) Patent Application Publication
(10) Pub. No.: US 2015/0326405 A1
(43) Pub. Date: Nov. 12, 2015

(54) MULTICAST TRAFFIC BRIDGING

(71) Applicants: Steven J. SHELLHAMMER, San Diego, CA (US); Xuguang LI, San Diego, CA (US); Patrick STUPAR, San Diego, CA (US); QUALCOMM INCORPORATED, San Diego, CA (US); Tienchuan KO, San Diego, CA (US); Honger NIE, San Diego, CA (US); Xinyu HU, San Diego, CA (US); Andrea GARAVAGLIA, San Diego, CA (US)

(72) Inventors: Tienchuan Ko, Saratoga, CA (US); Honger Nie, Beijing (CN); Xinyu Hu, Shanghai (CN); Andrea J. Garavaglia, Nuremberg (DE); Stephen J. Shellhammer, Ramona, CA (US); Xuguang Li, San Diego, CA (US); Patrick Stupar, Nuremberg (DE)

(21) Appl. No.: 14/652,696

(22) PCT Filed: Dec. 17, 2012
(86) PCT No.: PCT/CN2012/086767

§ 371 Date: Jun. 16, 2015

(51) Int. Cl. H04L 12/18; H04B 10/27

(52) U.S. Cl. CPC H04L 12/18; H04B 10/27

(57) ABSTRACT

A fiber-coax unit (FCU) is coupled to an optical line terminal (OLT) and a plurality of coax network units (CNUs). The FCU receives a multicast frame from the OLT. The multicast frame includes a first multicast logical link identifier (LLID) dedicated for multicast traffic directed to CNUs. The FCU replaces the first multicast LLID in the multicast frame with a second multicast LLID corresponding to one or more multicast groups that include at least one CNU of the plurality of CNUs. The FCU transmits the multicast frame to the plurality of CNUs.

### TECHNICAL FIELD

The present embodiments relate generally to multicasting, and specifically to multicasting in communication systems with both optical fiber links and coaxial cable (“coax”) links.

### BACKGROUND OF RELATED ART

Multicast logical link identifiers (LLIDs) may be used to implement multicasting in a passive optical network, such as a network implemented using the Ethernet Passive Optical Networks (EPON) protocol. A passive optical network may be extended over coax. For example, the EPON protocol may be extended over coaxial cable plants. EPON over coax is called EPoC. When such a network is extended over coax, limitations on the number of multicast LLIDs in the optical portion of the network may result in an insufficient number of multicast LLIDs in coax portions of the network.

### BRIEF DESCRIPTION OF THE DRAWINGS

The present embodiments are illustrated by way of example and are not intended to be limited by the figures of the accompanying drawings.

FIGS. 1A and 1B are block diagrams of a network that includes both optical fiber links and coax links in accordance with some embodiments.

FIG. 1C is a block diagram of a portion of the network of FIGS. 1A and 1B in accordance with some embodiments.

FIG. 2 is a block diagram of a frame in accordance with some embodiments.

FIG. 3 illustrates a multicast authorization and registration sequence for the network components of FIG. 1C in accordance with some embodiments.

FIG. 4 is a flowchart illustrating a method of performing multicasting in a network that includes both optical fiber links and coax links, in accordance with some embodiments.

FIG. 5A is a block diagram of a fiber-coax unit in accordance with some embodiments.

FIG. 5B is a block diagram of an optical line terminal in accordance with some embodiments.

Like reference numerals refer to corresponding parts throughout the drawings and specification.

### DETAILED DESCRIPTION

Embodiments are disclosed in which a dedicated multicast logical link identifier (LLID) is used to implement a channel for multicast traffic from an optical line terminal (OLT) to one or more fiber-coax units (FCUs).

In some embodiments, a method of multicasting is performed in an FCU coupled to an OLT and a plurality of coax network units (CNUs). The FCU receives a multicast frame from the OLT. The multicast frame includes a first multicast LLID for multicast traffic from the OLT to the FCU. The FCU replaces the first multicast LLID in the multicast frame with a second multicast LLID corresponding to one or more multicast groups that include at least one CNU of the plurality of CNUs. The FCU then transmits the multicast frame to the plurality of CNUs.

In some embodiments, an FCU includes an optical network unit (ONU) to receive a multicast frame from an OLT. The multicast frame includes a first multicast LLID for multicast traffic from the OLT to the FCU. The FCU is configured to replace the first multicast LLID with a second multicast LLID corresponding to one or more multicast groups that include at least one CNU of the plurality of CNUs. The FCU also includes a coax line terminal (CLT) to transmit the multicast frame to a plurality of CNUs and a MAC bridge to couple the ONU to the CLT.

In some embodiments, a non-transitory computer-readable storage medium stores instructions that, when executed by a processor in an FCU, cause the FCU to replace a first multicast LLID in a multicast frame received from an OLT with a second multicast LLID. The first multicast LLID is for multicast traffic from the OLT to the FCU and the second multicast LLID corresponds to one or more multicast groups that include at least one of a plurality of CNUs coupled to the FCU. The non-transitory computer-readable storage medium also stores instructions that, when executed by the processor in the FCU, cause the FCU to transmit the multicast frame to the plurality of CNUs.

In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

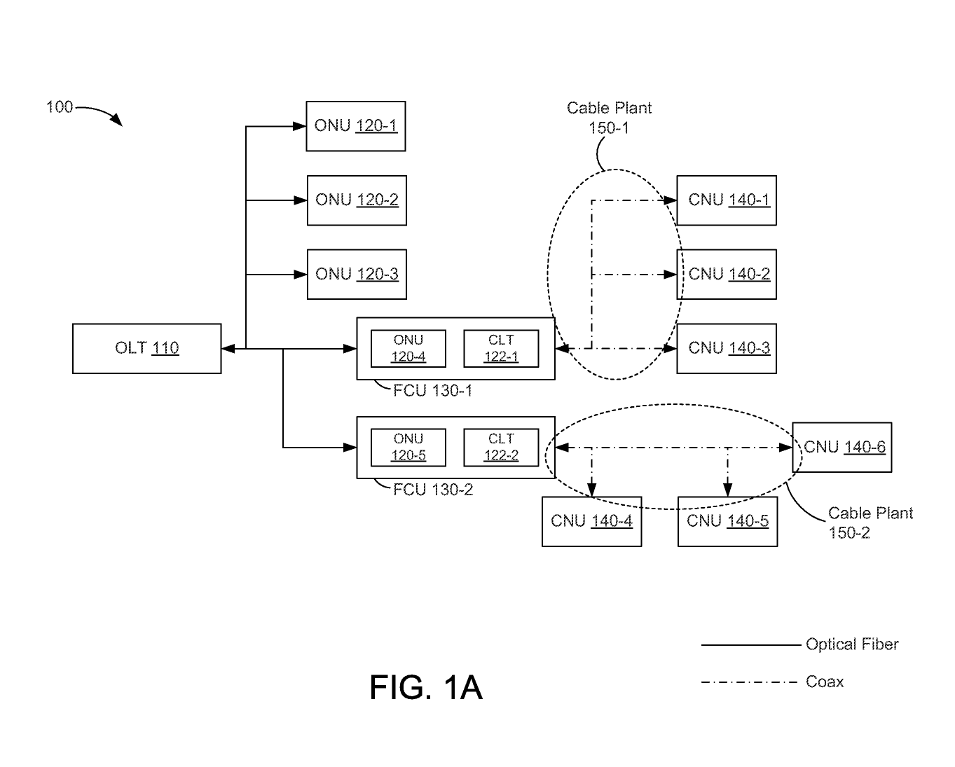

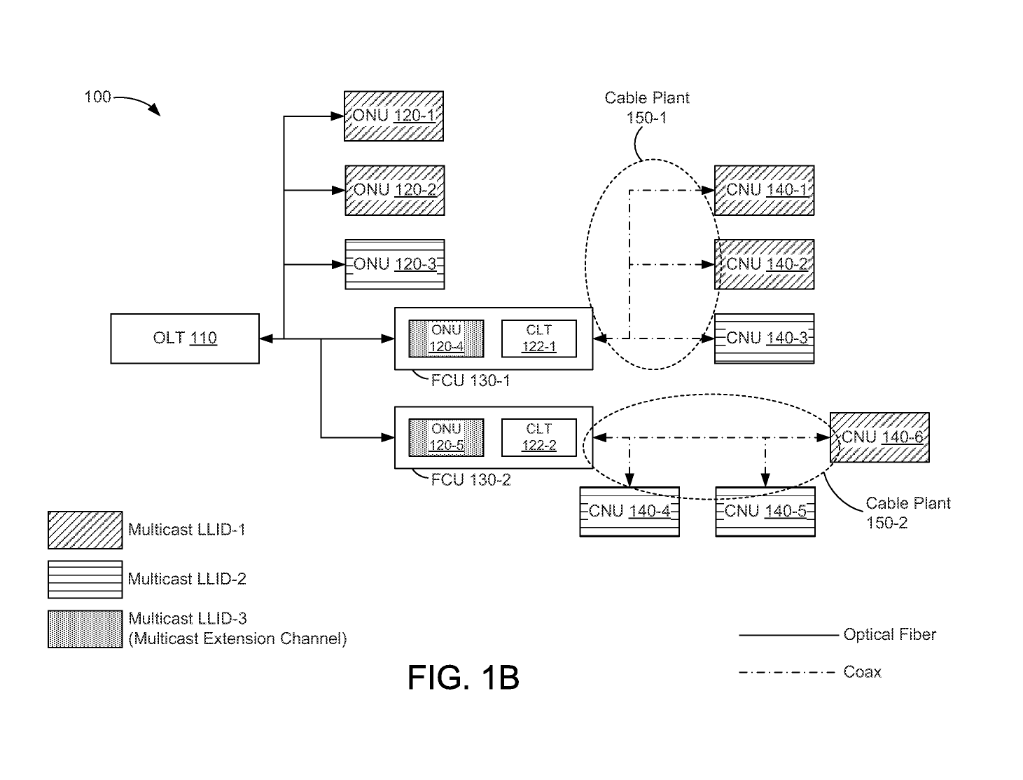

FIG. 1A is a block diagram of a network 100 that includes both optical fiber links and coax links in accordance with some embodiments. The network 100 includes an optical line terminal (OLT) 110 (which may also be referred to as an optical link terminal) coupled to a plurality of optical network units (ONUs) 120-1, 120-2, and 120-3 via respective optical fiber links. The OLT 110 also is coupled to a plurality of fiber-coax units (FCUs) 130-1 and 130-2 via respective optical fiber links. The FCUs 130-1 and 130-2, which may also be referred to as optical-coax units (OCUs), perform bridge forwarding of signals from the OLT 110 to coax network units (CNUs) 140-1 through 140-6 and of signals from the CNUs 140-1 through 140-6 to the OLT 110. The FCUs 130-1 and 130-2 convert optical signals from the OLT 110 into electrical signals and transmit the electrical signals to the CNUs 140-1 through 140-6 via respective coax links. In the example of FIG. 1, a first FCU 130-1 transmits converted signals to CNUs 140-1, 140-2, and 140-3, and a second FCU 130-2 transmits converted signals to CNUs 140-4, 140-5, and 140-6. Similarly, the FCUs 130-1 and 130-2 convert electrical signals from the CNUs 140-1 through 140-6 into optical signals and transmit the optical signals to the OLT 110. The coax links coupling the first FCU 130-1 to CNUs 140-1, 140-2, and 140-3 compose a first cable plant 150-1. The coax links coupling the second FCU 130-2 to CNUs 140-4, 140-5, and 140-6 compose a second cable plant 150-2. Each of the CNUs 140-1 through 140-6 may be coupled to one or more pieces of customer premise equipment (CPE, not shown in FIG. 1A), such as a set-top box or personal computer.

Each of the FCUs 130-1 and 130-2 includes a fiber portion, which may be referred to as an FCU-F, and a coax portion, which may be referred to as an FCU-C. In the example of FIG. 1A, the fiber portions are implemented as ONUs 120-4 and 120-5 and the cable portions are implemented as coax line terminals (CLTs) 122-1 and 122-2. Coax line terminals may also be referred to as coax link terminals. The ONUs 120-4 and 120-5 in the FCU 130-1 and 130-2 are coupled to the OLT 110 by optical links. The CLTs 122-1 and 122-2 in the FCU 130-1 and 130-2 are coupled to respective CNUs 140 (e.g., CNUs 140-1 through 140-3, or CNUs 140-4 through 140-6) by coax links.

In some embodiments, the OLT 110 and ONUs 120-1 through 120-5 are implemented in accordance with the Ethernet Passive Optical Network (EPON) protocol.

In some embodiments, the OLT 110 is located at the network operator's headend, the ONUs 120-1 through 120-3 and CNUs 140-1 through 140-6 are located at the premises of respective users, and the FCUs 130-1 and 130-2 are located at the headends of respective cable plant operators. Alternatively, FCUs 130-1 and 130-2 may be located within cable plants.

The ONUs 120-1 through 120-5 each receive all of the frames transmitted by the OLT 110. For unicast transmissions, each of the ONUs 120-1 through 120-3 receives every frame transmitted by the OLT 110, but selects only the frames addressed to it (e.g., addressed to its logical link identifier (LLID)), and drops all frames that are not addressed to it. In some embodiments, the FCUs 130-1 and 130-2 receive every unicast frame transmitted by the OLT 110 and filter out those frames not addressed to the ONU 120-4 or 120-5 (e.g., not addressed to the LLID of the ONU 120-4 or 120-5). (In some embodiments, a unicast frame transmitted from the OLT 110 and ultimately intended for a CNU 140 coupled to the FCU 130-1 or 130-2 has the LLID of the corresponding ONU 120-4 or 120-5 and also has the MAC address of the CNU 140. The FCU 130-1 or 130-2 may filter frames based on the LLID.)

In addition to unicast transmissions addressed to specific ONUs 120-1 through 120-5, the network 100 may also convey multicast transmissions. In a multicast transmission, a single multicast frame transmitted downstream by the OLT 110 is directed to a multicast group that may include one or more of the ONUs 120-1 through 120-3 or one or more of the ONUs 120-4 and 120-5. Every device in the multicast group receives and processes the multicast frame. Devices that are not in the multicast group, however, drop the multicast frame. Each of the ONUs 120-1 through 120-3 may belong to multiple multicast groups, or to no multicast groups, and different ONUs 120-1 through 120-3 may belong to identical, overlapping, or distinct sets of multicast groups. Likewise, each of the ONUs 140-4 and 140-5 may belong to multiple multicast groups, or to no multicast groups, and the ONUs 140-4 and 140-5 may belong to identical, overlapping, or distinct sets of multicast groups.

Furthermore, the CNUs 140-1 through 140-6 may belong to multicast groups. Each of the CNUs 140-1 through 140-6 may belong to multiple multicast groups, or to no multicast groups, and different CNUs 140-1 through 140-6 may belong to identical, overlapping, or distinct sets of multicast groups. In some embodiments, a CNU 140 is said to belong to a multicast group when at least one piece of customer premise equipment coupled to the CNU 140 belongs to the multicast group. Multicast transmissions from the OLT 110 that are ultimately intended for a multicast group that includes one or more of the CNUs 140-1 through 140-6 are forwarded through the FCUs 130-1 and/or FCU 130-2.

Multicast groups may be identified using multicast logical link identifiers (LLIDs) and/or multicast group media access control (MAC) addresses. For example, each multicast group is assigned a distinct multicast group MAC address and associated with a multicast LLID. The relationship between multicast LLIDs and multicast group MAC addresses may be one-to-one, such that each multicast LLID corresponds to a distinct multicast group MAC address and thus to a distinct multicast group, or one-to-many, such that each multicast LLID corresponds to a plurality of multicast group MAC addresses and thus to a plurality of multicast groups.

The number of multicast LLIDs that each of the ONUs 120-1 through 120-5 can accommodate is limited (e.g., to four or eight multicast LLIDs). This limitation may result in a shortage of multicast LLIDs in the cable portions of the network 100 (e.g., for the cable plants 150-1 and 150-2). To increase the number of multicast LLIDs available in the cable portions of the network 100, each ONU 120-4 and 120-5 in an FCU 130-1 or 130-2 is assigned a single multicast LLID used for all multicast transmissions from the OLT 110 to the FCUs 130-1 and/or 130-2. In some embodiments, all of the ONUs 120-4 and 120-5 are assigned the same multicast LLID, which is thus used for all multicast frames transmitted from the OLT 110 that are ultimately intended for a multicast group that includes one or more of the CNUs 140-1 through 140-6. Each FCU 130-1 and 130-2 replaces this multicast LLID with a second LLID corresponding to the multicast group for which a respective multicast frame is intended and forwards the frame to the CNUs 140 on its cable plant, assuming at least one of the CNUs 140 is in the multicast group (or in a multicast group corresponding to the second LLID). The multicast LLID assigned to the ONUs 120-4 and 120-5 acts as a multicast extension channel for distribution of multicast transmissions from the OLT 110 to the FCUs 130-1 and 130-2. The multicast extension channel allows multicast LLIDs that are used in the optical portion of the network 100 to be reused in coax portions of the network 100.

FIG. 1B shows an example of the network 100 in which different ONUs 120-1 through 120-5 and CNUs 140-1 through 140-6 are associated with different multicast LLIDs in accordance with some embodiments. ONUs 120-1 and 120-2 are in a first multicast group associated with a first multicast LLID (multicast LLID-1). ONU 120-3 is in a second group associated with a second multicast LLID (multicast LLID-2). CNUs 140-1, 140-2, and 140-6 are in a third multicast group that is also associated with the first multicast LLID (multicast LLID-1). CNUs 140-3, 140-4, and 140-5 are in a fourth multicast group that is also associated with the second multicast LLID (multicast LLID-2). A third multicast LLID (multicast LLID-3) is assigned to the ONUs 120-4 and 120-5 in the FCUs 130-1 and 130-2. The third multicast LLID provides the multicast extension channel.

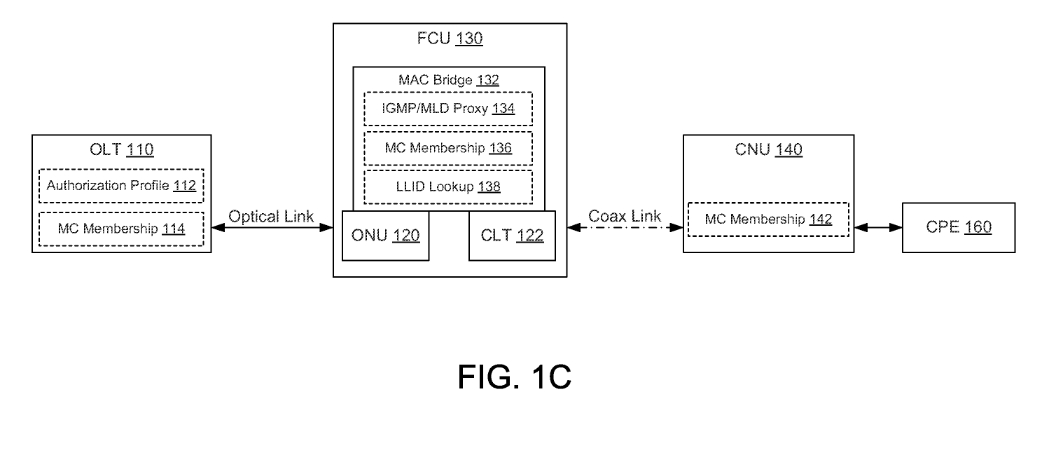

All multicast frames transmitted by the OLT 110 that are directed to the group of CNUs 140-1, 140-2, and 140-6 include the third multicast LLID (e.g., in a preamble 202, FIG. 2). The ONUs 120-1 through 120-3 drop these frames. The FCUs 130-1 and 130-2 receive these frames, replace the third multicast LLID with the first multicast LLID, and forward the frames to the CNUs 140-1 through 140-6. The CNUs 140-1, 140-2, and 140-6 receive and process the frames, while the CNUs 140-3, 140-4, and 140-5 drop the frames.

Similarly, all multicast frames transmitted by the OLT 110 that are directed to the group of CNUs 140-3, 140-4, and 140-5 include the third multicast LLID (e.g., in a preamble 202, FIG. 2). The ONUs 120-1 through 120-3 drop these frames. The FCUs 130-1 and 130-2 receive these frames, replace the third multicast LLID with the second multicast LLID, and forward the frames to the CNUs 140-1 through 140-6. The CNUs 140-3, 140-4, and 140-5 receive and process the frames, while the CNUs 140-1, 140-2, and 140-6 drop the frames.

FIG. 1C is a block diagram of a portion of the network 100 of FIGS. 1A and 1B in accordance with some embodiments. The OLT 110 is connected to an FCU 130 (e.g., the FCU 130-1 or 130-2, FIGS. 1A-1B) by an optical link. The FCU 130 is connected to a CNU 140 (e.g., one of the CNUs 140-1 through 140-6, FIGS. 1A-1B) by a coax link. The CNU 140 is connected to customer premise equipment (CPE) 160 (e.g., a personal computer or set-top box).

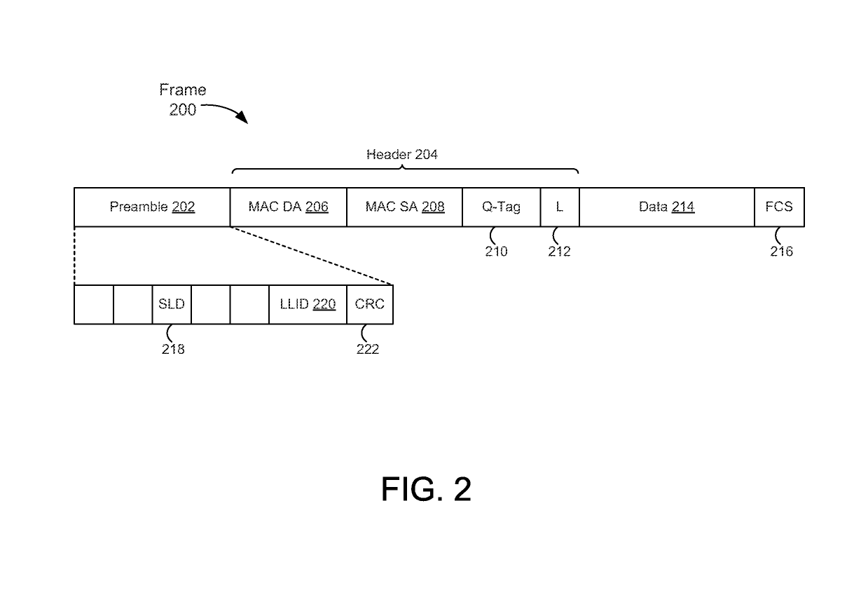

The CPE 160 may initiate a request to join a multicast group. This request triggers an authorization and registration process, which is described below with respect to FIG. 3. The OLT 110 includes an authorization profile 112 that indicates which ONUs 120-1 through 120-3 and which CNUs 140-1 through 140-6 may join which multicast groups. The OLT 110 also includes a multicast (MC) membership table 114, which maps the ONUs 120-1 through 120-3 and CLTs 122-1 through 122-2 to multicast groups (e.g. as represented by multicast group MAC addresses). If any of the CNUs 140-1 through 140-3 is in a multicast group, the corresponding CLT 122-1 will be mapped to the multicast group in the multicast membership table 114. If any of the CNUs 140-4 through 140-6 is in a multicast group, the corresponding CLT 122-2 will be mapped to the multicast group in the multicast membership table 114.

The multicast membership table 114 may also map multicast groups (e.g. as represented by multicast group MAC addresses) to multicast LLIDs, with all CNU multicast groups mapped to the multicast LLID for the multicast extension channel (e.g., LLID-3, FIG. 1B).

The FCU 130 includes a MAC bridge 132 that couples the ONU 120 (and thus the FCU-F) to the CLT 122 (and thus the FCU-C). The MAC bridge 132 includes a proxy 134 used in the multicast authorization and registration process (e.g., as illustrated in FIG. 3). In some embodiments, the proxy 134 is an Internet Group Management Protocol (IGMP) or Multicast Listener Discovery (MLD) proxy. The MAC bridge 132 also includes a multicast group membership table 136 that maps CNUs 140 to multicast groups (e.g. as represented by multicast group MAC addresses). The MAC bridge 132 further includes an LLID lookup table 138 that maps multicast groups (e.g. as represented by multicast group MAC addresses) to multicast LLIDs. The FCU 130 may use the LLID lookup table 138 to determine the multicast LLID with which to replace the multicast extension channel LLID in a multicast frame received from the OLT 110. While the multicast group membership table 136 and LLID lookup table 138 are shown as being implemented in the MAC bridge 132, they may be implemented in other locations in the FCU 130 (e.g., in the CLT 122).

The CNU 140 includes a multicast membership table 142 that lists the multicast groups to which the CNU 140 belongs. The multicast membership table 142 may also list the multicast LLIDs corresponding to the multicast groups.

FIG. 2is a block diagram of a frame 200, which may be a multicast frame, in accordance with some embodiments. The frame 200 includes a preamble 202, a header 204, a data field 214 that carries the payload of the frame 200, and a frame check sequence (FCS) 216. The preamble 202 includes a start-of-LLID delimiter 218, an LLID field 220, and a cyclic redundancy check (CRC) field 222, as well as other fields. The header 204 includes a MAC destination address (MAC DA) field 206, a MAC source address (MAC SA) field 208, a Q-tag 210 for specifying a priority, and a length/type (L) field 212.

When the frame 200 is a multicast frame, the MAC DA field 206 includes the multicast group MAC address of the multicast group to which the frame 200 is addressed and the LLID field 220 includes either the corresponding multicast LLID or the multicast extension channel LLID. In the example of FIG. 1B, a multicast frame 200 transmitted by the OLT 110 and directed to the multicast group that includes ONUs 120-1 and 120-2 has the first LLID (LLID-1) in the LLID field 220. A multicast frame 200 transmitted by the OLT 110 and directed to the multicast group that includes ONU 120-3 has the second LLID (LLID-2) in the LLID field 220. A multicast frame 200 transmitted by the OLT 110 and directed to the multicast group that includes CNUs 140-1, 140-2, and 140-6 has the multicast extension channel LLID (LLID-3) in the LLID field 220. The FCUs 130-1 and 130-2 remove this LLID from the LLID field 220 and write the first LLID (LLID-1) to the LLID field 220 instead. Similarly, a multicast frame 200 transmitted by the OLT 110 and directed to the multicast group that includes CNUs 140-3, 140-4, and 140-5 has the multicast extension channel LLID (LLID-3) in the LLID field 220. The FCUs 130-1 and 130-2 remove this LLID from the LLID field 220 and write the second LLID (LLID-2) to the LLID field 220 instead. In some embodiments, the FCUs 130-1 and 130-2 determine the LLID with which to replace the multicast extension channel LLID (LLID-3) by reading the multicast group MAC address from the MAC DA field 206 and performing a look-up in the LLID lookup table 138 (FIG. 1C) using the multicast group MAC addressas an input.

FIG. 3 illustrates a multicast group authorization and registration sequence for the network components of FIG. 1C in accordance with some embodiments. CPE 160 coupled to a CNU 140 generates a join request 302 to join a multicast group. In some embodiments the join request 302 is an IGMP or MLD join request. The CNU 140 forwards the join request 302 to the FCU 130.

In response to the join request 302, the FCU 130 generates a multicast authorization request message 304 on behalf of the CNU 140. The ONU 120 in the FCU 130 transmits the multicast authorization request message 304 to the OLT 110. In some embodiments, the multicast authorization request message 304 is an operations, administration, and management (OAM) multicast authorization request message generated by an OAM layer or sub-layer in the FCU 130. Upon receiving the multicast authorization request message 304, the OLT 110 performs a lookup 306 in the authorization profile 112 (FIG. 1C) to determine whether the CNU 140 is authorized to join the multicast group. If the CNU 140 is authorized to join the multicast group, the OLT 110 generates and transmits a message 308 (e.g., an OAM message) to the FCU 130 granting authorization to join the multicast group.

In response to the message 308, the FCU 130 generates a message 310 (a “Multicast LLID Registration—Register” message) registering the CNU 140 with the LLID corresponding to the multicast group. The CLT 122 transmits the message 310 to the CNU 140. In some embodiments, the message 310 is an OAM message. Based on the message 310, the CNU 140 adds the LLID and/or multicast group to its multicast membership table 142 (FIG. 1C). At this point, the CNU 140 is ready (312) to receive multicast traffic through the multicast LLID corresponding to the multicast group.

Also in response to the message 308, the FCU 130 (e.g., the proxy 134, FIG. 1C) generates a join request 314 to join the multicast group (e.g., if the CNU 140 is the first CNU coupled to the FCU 130 to join the multicast group), which the ONU 120 transmits to the OLT 110. The join request 314 is thus a request to associate the FCU 130 with the multicast group. In some embodiments, the OLT 110 skips (316) the lookup in the authorization profile 112 (FIG. 1C), since the join request 314 is for the FCU 130. The OLT generates a message 318 (a “Multicast LLID Registration—Register” message) registering the FCU 130 (e.g., the ONU 120) with the LLID corresponding to the multicast group and confirming association of the FCU 130 with the multicast group. Based on the message 318, the FCU 130 adds the multicast group to the multicast group membership table 136. The OLT 110 may now transmit (320) multicast traffic for the multicast group to the FCU 130 using the multicast extension channel LLID (e.g., LLID-3, FIG. 1B). The MAC bridge 132 forwards (322) this traffic from the ONU 120 to the CLT 122. The FCU 130 replaces the multicast extension channel LLID with the multicast LLID for the multicast group (i.e., the designated LLID) and transmits (324) the multicast traffic to the CNU 140, which forwards the traffic to the CPE 160.

The CPE 160 may initiate (326) a leave operation and generate a leave request 328 (e.g., an IGMP or MLD leave request) to leave the multicast group. The CNU 140 forwards the leave request 328 to the CLT 122. In response, the CLT 122 transmits a group-specific query 330 (e.g., an IGMP or MLD group-specific query) to query whether any other CPEs 160 coupled to the CLT 122 are members of the multicast group (or of another multicast group that shares the same LLID). The CLT 122 also transmits a message 332 (a “Multicast LLID Registration—De-allocate” message, which may be an OAM message) to the CNU 140, in response to which the CNU 140 removes the multicast group and/or corresponding LLID from its multicast membership table 142 (FIG. 1C).

If the CPE 160 that generated the leave request 328 the only CPE 160 coupled to the CLT 122 that is a member of the multicast group (or of another multicast group that shares the same LLID), the FCU 130 (e.g., the proxy 134, FIG. 1C) generates a leave request 334 (e.g., an IGMP or MLD leave request) to leave the multicast group. The ONU 120 transmits the leave request 334 to the OLT 110, which responds with a message 336 (a “Multicast LLID Registration—De-allocate” message, which may be an OAM message). In response, the FCU 130 de-allocates the LLID of the multicast group. The FCU 130 may remove the LLID from the LLID lookup table 138 (FIG. 1C) and may remove the multicast group from the multicast group membership table 136 (FIG. 1C). The leave request 334 is thus a request to disassociate the FCU 130 from the multicast group, and the message 336 confirms disassociation of the FCU 130 from the multicast group. At this point, the OLT 110 stops (338) forwarding multicast traffic for the multicast group (or for all multicast groups with the corresponding LLID) to the FCU 130. However, if another FCU 130 in the network 100 (FIG. 1) is coupled to a CNU 140 in the multicast group (or a multicast group sharing the corresponding LLID), the OLT 110 may continue to forward multicast traffic for the multicast group (or for all multicast groups with the corresponding LLID).

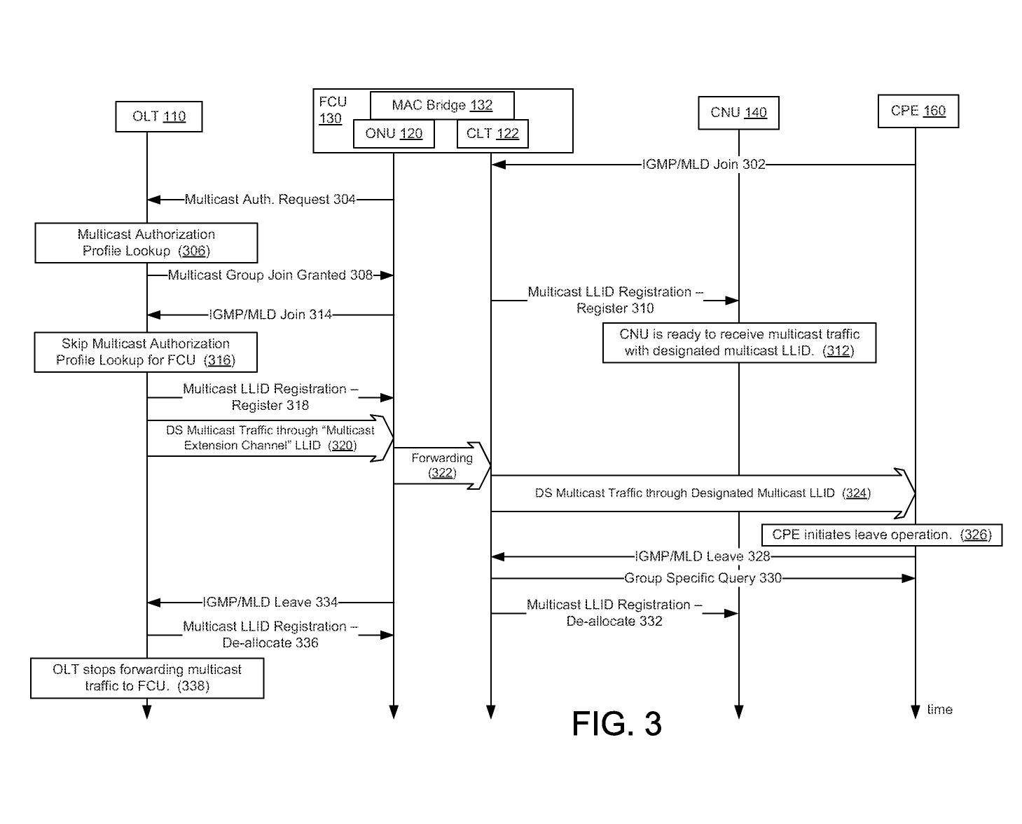

FIG. 4 is a flowchart illustrating a method 400 of performing multicasting in accordance with some embodiments. The method 400 is performed (402) in an FCU 130 (FIG. 1C) (e.g., the FCU 130-1 or 130-2, FIGS. 1A-1B).

A multicast frame is received (404) from the OLT 110. The multicast frame includes a first multicast logical link identifier (LLID) for multicast traffic from the OLT 110 to the FCU 130 (e.g., LLID-3 for the multicast extension channel, FIG. 1B, which is used for all multicast traffic from the OLT 110 to the FCU 130). In some embodiments, the multicast frame also includes (406) a multicast group MAC address. For example, the multicast frame is a frame 200 (FIG. 2) with the first multicast LLID in the LLID field 220 of the preamble 202 and the multicast group MAC address in the MAC DA field 206 of the header 204.

The FCU 130 replaces (408) the first multicast LLID in the multicast frame with a second multicast LLID corresponding to one or more multicast groups that include at least one CNU of the plurality of CNUs. In some embodiments, the FCU 130 selects (410) the second multicast LLID based on the multicast group MAC address. For example, the FCU 130 uses the multicast group MAC address to query the LLID lookup table 138 (FIG. 1C).

In some embodiments, the FCU 130 verifies (412) that the multicast group MAC address maps to at least one CNU 140 of the plurality of CNUs 140 (e.g., CNUs 140-1 through 140-3 or 140-4 through 140-6, FIGS. 1A-1B) coupled to the FCU 130. For example, the FCU 130 performs this verification by querying the multicast group membership table 136.

The FCU 130 transmits (414) the multicast frame to the plurality of CNUs 140 to which it is coupled.

The FCU 130 drops (416) multicast frames from the OLT 110 that have multicast LLIDs distinct from the first multicast LLID. For example, the FCU 130 drops multicast frames that have LLID-1 or LLID-2 (FIG. 1B) in the LLID field 220 of their preambles 202.

While the method 400 includes a number of operations that appear to occur in a specific order, it should be apparent that the method 400 can include more or fewer operations. For example, the dropping 416 may be omitted from the method 400. An order of two or more operations may be changed, performance of two or more operations may overlap, and two or more operations may be combined into a single operation. The method 400 may also be combined with all or a portion of the multicast group authorization and registration procedure of FIG. 3.

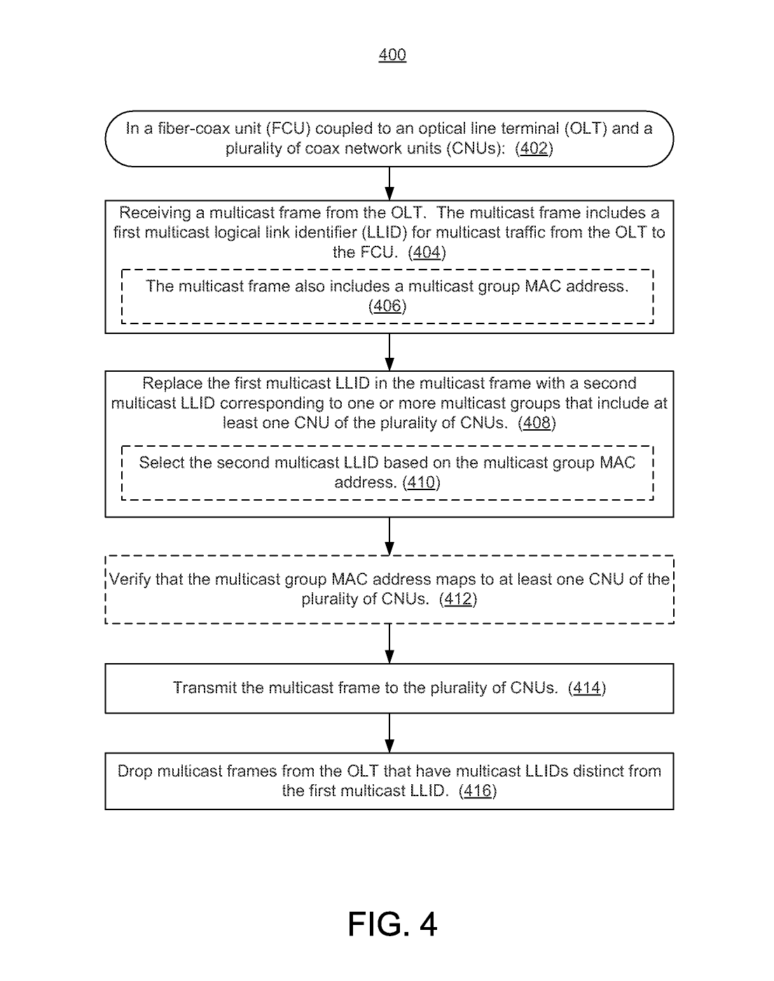

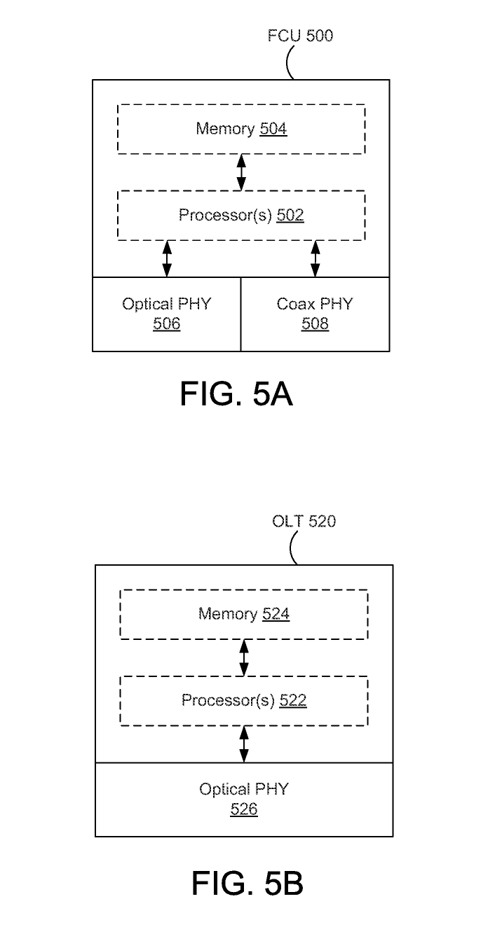

In some embodiments, the functionality of the MAC bridge 132 (FIG. 1C) and a portion of the functionality (e.g., all functionality above the physical layer) of the ONU 120 and CLT 122 in an FCU 130 (FIG. 1C) are implemented in software. For example, FIG. 5A is a block diagram of an FCU500 in a network such as the network 100 (FIGS. 1A-1B) in accordance with some embodiments. The FCU500 is an example of an FCU 130 (FIG. 1C) (e.g., an FCU 130-1 or 130-2, FIGS. 1A-1B). The FCU500 includes an optical physical layer (PHY)506, which is part of the ONU 120 (FIG. 1C), and a coax PHY 508, which is part of the CLT 122 (FIG. 1C). The optical PHY 506 and coax PHY 508 are coupled to one or more processors 502, which are coupled in turn to memory 504. The memory 504 includes a non-transitory computer-readable medium (e.g., one or more nonvolatile memory elements, such as EPROM, EEPROM, Flash memory, a hard disk drive, and so on) that stores instructions for execution by the one or more processors 502. In some embodiments, the instructions include instructions that, when executed by the processor(s) 502, cause the FCU500 to perform all or a portion of the method 400 (FIG. 4). In some embodiments, the instructions include instructions that, when executed by the processor(s) 502, cause the FCU 500 to perform the portion of the multicast group authorization and registration procedure of FIG. 3 for the FCU 130.

While the memory 504 is shown as being separate from the processor(s)502, all or a portion of the memory 504 may be embedded in the processor(s)502. In some embodiments, the processor(s) 502 and/or memory 504 are implemented in the same integrated circuit as the optical PHY 506 and/or coax PHY 508.

FIG. 5B is a block diagram of an OLT520 in accordance with some embodiments. The OLT 520 is an example of the OLT 110 (FIGS. 1A-1C). In the OLT520, an optical PHY 526 is coupled to one or more processors 522, which are coupled in turn to memory 524. In some embodiments, the memory 524 includes a non-transitory computer-readable medium (e.g., one or more nonvolatile memory elements, such as EPROM, EEPROM, Flash memory, a hard disk drive, and so on) that stores instructions for execution by the one or more processors 522. In some embodiments, the instructions include instructions that, when executed by the processor(s) 522, cause the OLT 520 to generate and transmit the multicast frames for operations 404 and 416 of the method 400 (FIG. 4). In some embodiments, the instructions include instructions that, when executed by the processor(s) 522, cause the OLT 520 to perform the portion of the multicast group authorization and registration procedure of FIG. 3 for the OLT 110.

While the memory 524 is shown as being separate from the processor(s) 522, all or a portion of the memory 524 may be embedded in the processor(s) 522. In some embodiments, the processor(s) 522 and/or memory 524 are implemented in the same integrated circuit as the optical PHY 526.

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A method of multicasting, comprising:
in a fiber-coax unit (FCU) coupled to an optical line terminal (OLT) and a plurality of coax network units (CNUs):
receiving a multicast frame from the OLT, wherein the multicast frame comprises a first multicast logical link identifier (LLID) for multicast traffic from the OLT to the FCU;
replacing the first multicast LLID in the multicast frame with a second multicast LLID corresponding to one or more multicast groups that include at least one CNU of the plurality of CNUs; and
transmitting the multicast frame to the plurality of CNUs.

2. The method of claim 1, wherein:
the multicast frame further comprises a multicast group MAC address; and
replacing the first multicast LLID in the multicast frame with the second multicast LLID comprises selecting the second multicast LLID based on the multicast group MAC address.

3. The method of claim 2, further comprising storing a lookup table in the FCU that maps multicast group MAC addresses to multicast LLIDs;
wherein selecting the second multicast LLID based on the multicast group MAC address comprises querying the lookup table.

4. The method of claim 2, wherein the multicast frame as received from the OLT comprises a preamble containing the first multicast LLID and a header containing the multicast group MAC address.

5. The method of claim 2, further comprising storing a multicast group membership table in the FCU that maps multicast groups to respective CNUs of the plurality of CNUs.

6. The method of claim 5, further comprising verifying that the multicast group MAC address of the multicast frame maps to at least one CNU in the multicast group membership table;
wherein the transmitting is performed in response to the verifying.

7. The method of claim 1, further comprising dropping multicast frames from the OLT that have multicast LLIDs distinct from the first multicast LLID.

8. The method of claim 1, further comprising, in the FCU:
receiving a first request from a first CNU of the plurality of CNUs to join a first multicast group;
transmitting a second request to the OLT for authorization to add the first CNU to the first multicast group; and
receiving authorization from the OLT to add the first CNU to the first multicast group.

9. The method of claim 8, wherein:
the first request comprises an Internet Group Management Protocol (IGMP) or Multicast Listener Discovery (MLD) join message; and
the second request comprises an operations, administration, and management (OAM) multicast authorization request message.

10. The method of claim 8, further comprising, in the FCU:
in response to receiving the authorization, transmitting a third request to the OLT to associate the FCU with the first multicast group; and
receiving a registration message from the OLT confirming association of the FCU with the first multicast group.

11. The method of claim 8, further comprising, in the FCU:
receiving a fourth request from the first CNU to leave the first multicast group; and
transmitting a message to the first CNU to remove the first multicast group from a multicast group membership table in the first CNU.

12. The method of claim 11, wherein the first multicast group is associated with a respective multicast LLID distinct from the first multicast LLID, the method further comprising, in the FCU:
verifying that, once the first CNU leaves the first multicast group, no CNUs of the plurality of CNUs will be in a multicast group associated with the respective multicast LLID; and
de-allocating the respective multicast LLID on the first CNU.

13. The method of claim 12, wherein:
the fourth request comprises an IGMP or MLD leave message; and
the verifying comprises transmitting an IGMP or MLD group-specific query to the plurality of CNUs.

14. The method of claim 11, further comprising, in the FCU:
transmitting a fifth request to the OLT to leave the first multicast group, the fifth request comprising an IGMP or MLD leave; and
receiving an OAM message from the OLT de-allocating the respective multicast LLID.

15. A fiber-coax unit (FCU), comprising:
an optical network unit (ONU) to receive a multicast frame from an OLT, wherein the multicast frame comprises a first multicast LLID for multicast traffic from the OLT to the FCU;
a coax line terminal (CLT) to transmit the multicast frame to a plurality of CNUs; and
a MAC bridge to couple the ONU to the CLT;
wherein the FCU is to replace the first multicast LLID with a second multicast LLID corresponding to one or more multicast groups that include at least one CNU of the plurality of CNUs.

16. The FCU of claim 15, wherein:
the multicast frame further comprises a multicast group MAC address; and
the FCU further comprises a lookup table to map the multicast group MAC address to the second multicast LLID.

17. The FCU of claim 16, wherein:
the FCU further comprises a multicast group membership table to map multicast groups to respective CNUs of the plurality of CNUs; and
the FCU is to verify that the multicast group MAC address is in the multicast group membership table before transmitting the multicast frame to the plurality of CNUs.

18. The FCU of claim 15, wherein the FCU is to drop multicast frames received from the OLT that have multicast LLIDs distinct from the first multicast LLID.

19. The FCU of claim 15, wherein:
the CLT is to receive a request from a CNU to join a multicast group;
the ONU is to transmit a message to the OLT requesting authorization for the CNU to join the multicast group; and
the MAC bridge comprises a proxy to generate a request to be transmitted to the OLT to join the multicast group, in response to receiving the authorization from the OLT.

20. A non-transitory computer-readable storage medium storing instructions that, when executed by a processor in a fiber-coax unit (FCU), cause the FCU to:
replace a first multicast LLID in a multicast frame received from an OLT with a second multicast LLID, wherein the first multicast LLID is for multicast traffic from the OLT to the FCU and the second multicast LLID corresponds to one or more multicast groups that include at least one of a plurality of CNUs coupled to the FCU; and
transmit the multicast frame to the plurality of CNUs.
